(19) United States
(12) Patent Application Publication
(10) Pub. No.: US 2010/0062652 A1
(43) Pub. Date: Mar. 11, 2010

(54) POWER ADAPTER WITH CHANGEABLE PLUG

(76) Inventor: Wen-Chi Liu, Taoyuan Hsien (TW)

Correspondence Address: Muncy, Geissler, Olds & Lowe, PLLC, P.O. BOX 1364, FAIRFAX, VA, 22038-1364, US

(21) Appl. No.: 12/205,021

(22) Filed: Sep. 5, 2008

(51) Int. Cl. H01R 24/00

(52) U.S. Cl. 439/660

(57) ABSTRACT

A power adapter with a changeable plug includes a positioning surface and an electric connecting surface connected to an edge of the positioning surface. The plug has a positioning plate and an electric connecting plate corresponding to the positioning surface and the electric connecting surface. The electric connecting surface and the electric connecting plate have a first socket and a second socket, and the plug has a transmission terminal electrically connected to the second socket, such that the power adapter and the plug are disposed on different distal surface through the positioning surface and the electric connecting surface as well as the positioning plate and the electric connecting plate to improve the shortcomings of traditional power adapters having a poor contact when conducting components are worn out or damaged in a process of installing or removing the plug, so as to improve the quality of power transmission.

### FIELD OF THE INVENTION

The present invention relates to a power adapter with a changeable plug, and more particularly to a power adapter that can change its plug according to the specifications of an insert hole of a socket.

### BACKGROUND OF THE INVENTION

Since the voltage of city power varies in different countries, the use of electric appliances or equipment carried by travelers is restricted to the different voltages. Power supply devices with a switchable voltage are developed to fit the voltage requirement of a country where the travelers visit. Due to safety regulations set forth by different countries, insert holes are designed in different forms to distinguish different voltages supplied by different countries to prevent users from plugging in an electric equipment into a socket of inappropriate voltage that may damage the electric appliances or equipment or cause accidents. Obviously, the aforementioned electric appliance or equipment cannot be used universally in different countries. To solve this problem, power adapters with a changeable plug, have developed and disclosed in R.O.C. Pat. Nos. 412094, 421359, 1251390, M270473, M275522, M288047, M293586, M299961 and M321168, so that users can change a plug with corresponding pins according to different insert holes of a socket.

A common point of the foregoing patents resides on that a groove is disposed on a distal surface of the power adapter, and the groove has a slide rail or a slide trough for slidably installed the plug onto the distal surface of the power adapter, and the groove is divided into a rotary slide and a linear slide according to the way of sliding, and the power adapter and the plug are coupled to a positioning portion and a conducting plate on the distal surface, such that when the plug is slidably installed to the power adapter, the positioning portions are latched with each other, while the conducting plates are connected to constitute an electric connection. Since the positioning portion and the conducting plate are disposed on the same distal surface, the conducting plates of the plug and the power adapter must rub with the coupled distal surface before the positioning portions are latched and fixed with each other, when the plug is slidably installed to the power adapter. As a result, the conducting plates are worn out and damaged or cannot be connected properly, and the poor contact of the conducting plates affects the condition of supplying electric power.

### SUMMARY OF THE INVENTION

The primary objective of the present invention is to overcome the foregoing shortcomings of the prior art by maintaining the integrity of conducting components connected to a power supply device and a plug, so as to improve the life of the conducting components.

To achieve the foregoing objective, the present invention provides a power adapter with a changeable plug, and the adapter comprises a positioning surface and an electric connecting surface coupled to an edge of the positioning surface, and the plug has a positioning plate and an electric connecting plate corresponding to the positioning surface and the electric connecting surface, wherein the electric connecting surface and the electric connecting plate are connected to a first socket and a second socket respectively, and the plug has a transmission terminal electrically connected to the second socket, such that the power adapter and the plug are disposed on different distal surfaces by means of the positioning surface and the electric connecting surface as well as the positioning plate and the electric connecting plate. When the plug is installed to or removed from the power adapter, the first and second sockets will not rub the positioning plate and the positioning surface or result in damage.

Compared with the prior art, the present invention achieves the effect of improving the quality of electric power transmissions.

### BRIEF DESCRIPTION OF THE DRAWINGS

FIG. 1 is a perspective view of the present invention;

FIG. 2 is an exploded view of a structure in accordance with a first embodiment of the present invention;

FIG. 3 is a side view of a plug of the present invention;

FIG. 4 is an exploded view of a structure in accordance with a second embodiment of the present invention; and

FIG. 5 is an exploded view of a structure in accordance with a third embodiment of the present invention.

### DETAILED DESCRIPTION OF THE PREFERRED EMBODIMENTS

The technical characteristics of the present invention will become apparent with the detailed description of embodiments accompanied with related drawings as follows:

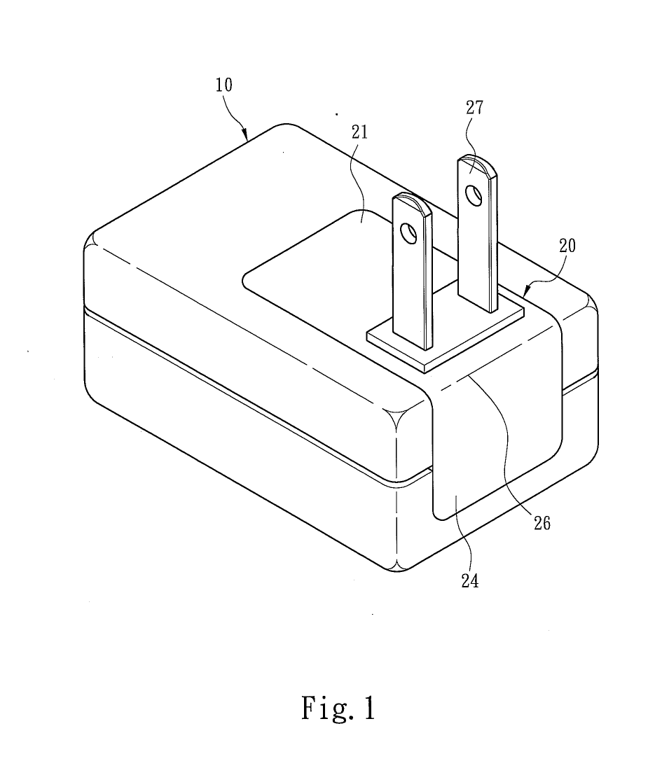

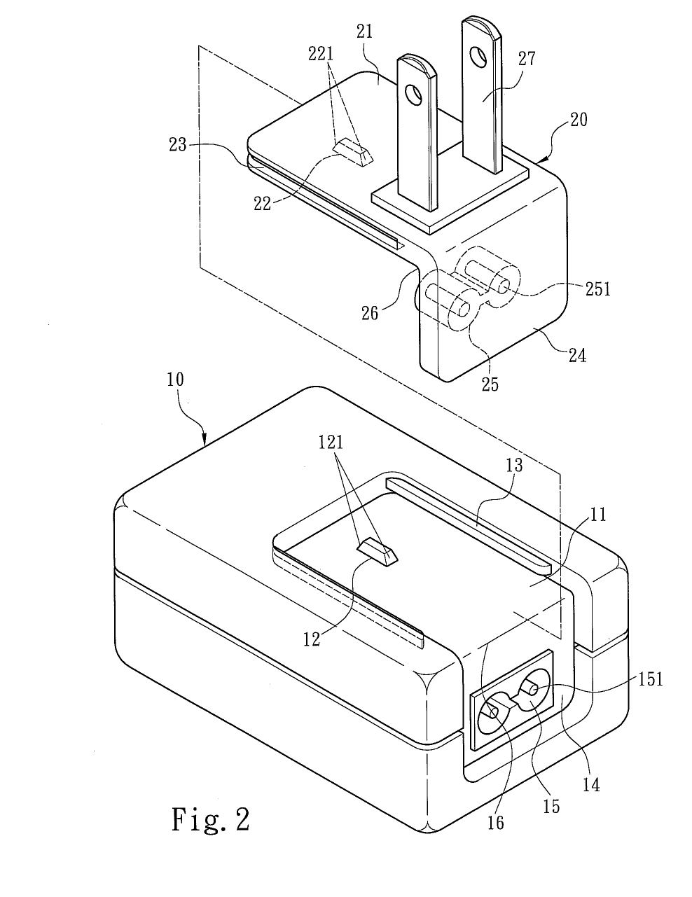

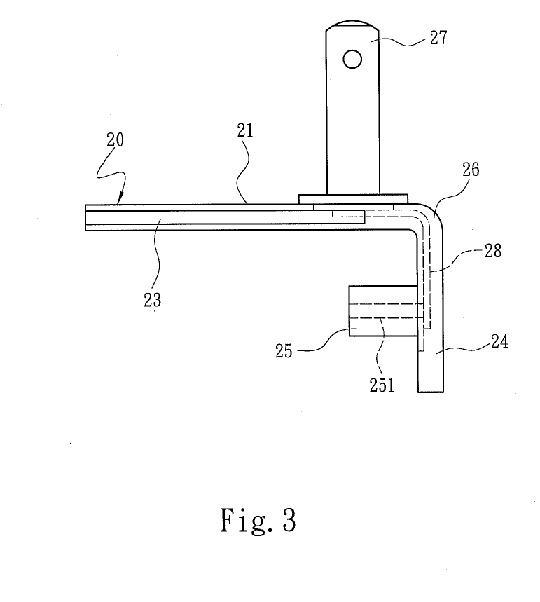

With reference to FIGS. 1 to 3, a power adapter with a changeable plug of the invention comprises a power adapter 10 and a plug 20 that can be installed to or removed from the power adapter 10. The power adapter 10 has a positioning surface 11 and an electric connecting surface 14 disposed on the positioning surface 11, and the plug 20 includes a positioning plate 21 corresponding to the positioning surface 11 and an electric connecting plate 24 disposed on the positioning plate 21 and corresponding to the electric connecting surface 14. A bent section 16, 26 is disposed separately between the positioning surface 11 and the electric connecting surface 14, and between the positioning plate 21 and the electric connecting plate 24, and the positioning surface 11 and the positioning plate 21 are perpendicular to the electric connecting surface 14 and the electric connecting plate 24 respectively, wherein the positioning surface 11 and the positioning plate 21 separately have a guide portion 13, 23, and the guide portions 13, 23 are a guide flange and a guide slide for assisting the plug 20 to be slidably coupled to the power adapter 10, and the positioning surface 11 and the positioning plate 21 have a first positioning portion 12 and a second positioning portion 22 constituting a connecting or separating relation, and the first positioning portion 12 and the second positioning portion 22 are a positioning block and a positioning groove engaged with each other, and two sliding oblique planes 121, 221 with a guide corner are disposed on both ends respectively. During assembly, the guide corner formed by the sliding oblique planes 121, 221 at both ends of the first positioning portion 12 and the second positioning portion 22 allows the first and second positioning portions 12, 22 to be latched with each other and fixed into a position, so as to assist the plug 20 to be stably fixed to the power adapter 10. During disassembly, the guide corner of the sliding oblique planes 121, 221 at both ends releases the positioning relation of the first and second positioning portions 12, 22 to separate the power adapter 10 and the plug 20.

The electric connecting surface 14 of the power adapter 10 and the electric connecting plate 24 of the plug 20 are coupled to a first socket 15 and a second socket 25, and the first socket 15 and the second socket 25 have conducting terminals 151, 251 for transmitting electric power, and the plug 20 has a transmission terminal electrically coupled to the second socket 25 as shown in the figure. The transmission terminal includes a pin 27 of the plug 20, and the plug 20 contains a conducting plate 28 of the pin 27 coupled to the second socket 25 and the pin 27 by an insert injection method, so that the pin 27 is electrically coupled to the second socket 25, and the second socket 25 and the first socket 15 constitute an electric connection, and the pin 27 is inserted into the socket for transmitting electric power to the power adapter 10. Therefore, the power adapter 10 may have a plug 20 with a corresponding pin 27 to fit the specification of the insert hole of the electric socket for transmitting electric power.

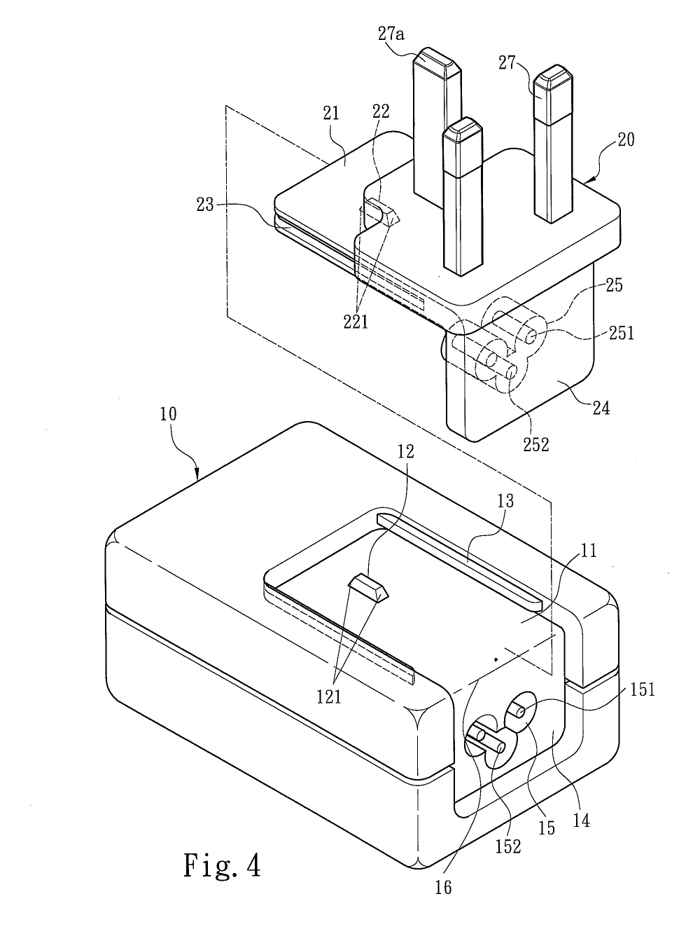

In a second embodiment of the present invention, the first socket 15 and the second socket 25 have conducting terminals 151, 251 and ground terminals 152, 252 as shown in FIG. 4. The transmission terminal includes a ground pin 27a of the plug 20, and the ground pin 27a is electrically coupled to the ground terminal 252 of the second socket 25, and the ground terminal 152 of the power adapter 10 is electrically connected, so as to meet the requirement of the electric power socket having a ground insert hole.

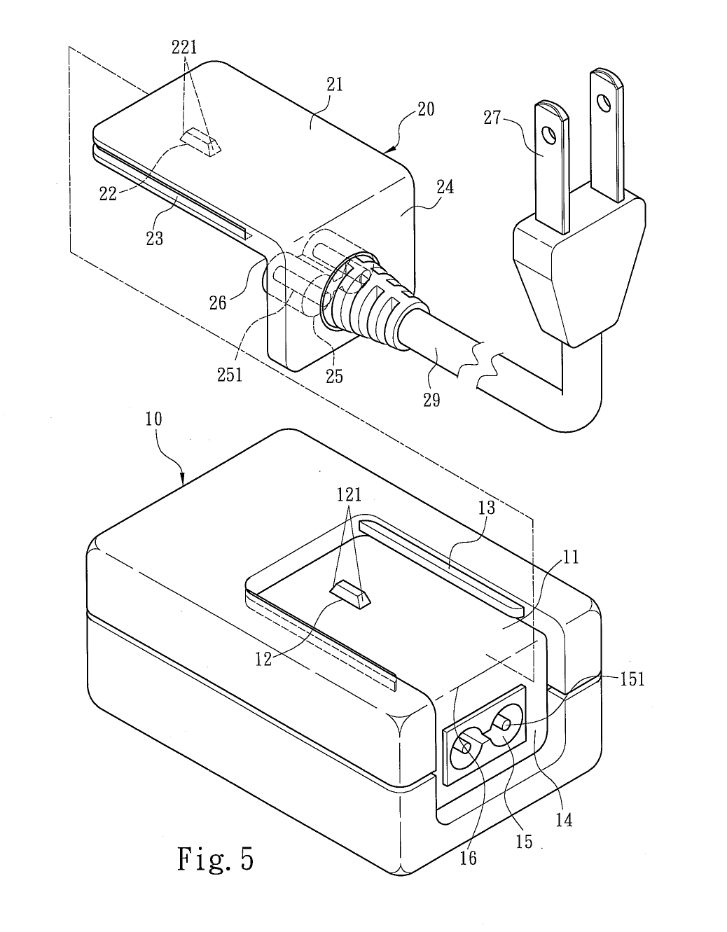

With reference to FIG. 5, the transmission terminal of the invention further comprises a power cable 29 disposed at the plug 20 and electrically coupled to the second socket 25, and an end of the power cable 29 has a pin 27, so that the power adapter 10 is not limited to be inserted into a wall socket only, but the power cable 29 can be used to extend the range of installing an electric appliance, and the first socket 15 and the second socket 25 are not limited to the conducting terminals 151, 251 as shown in the figure only, but the ground terminals 152, 252 may be designed to fit various models of sockets as shown in FIG. 4.

In summation of the description above, the present invention not only allows users to change the plug 20 to fit the specifications of different insert holes of electric power sockets for transmitting city power, but also designs the positioning surface 11 and the electric connecting surface 14 as well as the positioning plate 21 and the electric connecting plate 24 on different distal surfaces to prevent the second socket 25 and the first socket 15 from rubbing and wearing out the positioning plate 21 and the positioning surface 11 when assembling or changing the plug 20, so as to maintain the integrity of the structure of the second socket 25 and the first socket 15 and enhance the life of the power adapter.

From the description above, the present invention improves the quality of electric power transmission over the prior art.

While the invention has been described by means of specific embodiments, numerous modifications and variations could be made thereto by those skilled in the art without departing from the scope and spirit of the invention set forth in the claims.

What is claimed is:

1. A power adapter with a changeable plug, comprising: p1 a power adapter, having a positioning surface and an electric connecting surface coupled to an edge of the positioning surface, and the electric connecting surface having a first socket;
a plug, having a positioning plate corresponding to the positioning surface and an electric connecting plate connected to an edge of the positioning plate and corresponding to the electric connecting surface, and the electric connecting plate having a second socket coupled with the first socket, and the plug having a transmission terminal electrically coupled to the second socket.

2. The power adapter with a changeable plug of claim 1, wherein a bent section separately disposed between the positioning surface and the electric connecting surface, and between the positioning plate and the electric connecting plate.

3. The power adapter with a changeable plug of claim 1, wherein the transmission terminal includes a pin disposed at the plug and electrically coupled to the second socket.

4. The power adapter with a changeable plug of claim 3, wherein the plug includes a conducting plate disposed therein and coupled to the second socket and the pin.

5. The power adapter with a changeable plug of claim 1, wherein the transmission terminal includes a power cable installed at the plug and electrically coupled to the second socket, and a pin coupled to an end of the power cable.

6. The power adapter with a changeable plug of claim 1, wherein the positioning surface has a guide portion corresponding to the positioning plate.

7. The power adapter with a changeable plug of claim 6, wherein the guide portion is a guide flange or a guide slide.

8. The power adapter with a changeable plug of claim 1, wherein the positioning surface and the positioning plate respectively include a first positioning portion and a second positioning portion that constituting a coupling or separating relation.

9. The power adapter with a changeable plug of claim 8, wherein the first positioning portion and the second positioning portion are respectively positioning block and positioning groove latched with each other.

10. The power adapter with a changeable plug of claim 8, wherein the first positioning portion and the second positioning portion have two sliding oblique planes respectively.
